(19) United States
(12) Patent Application Publication
(10) Pub. No.: US 2026/0234509 A1
(43) Pub. Date: Aug. 13, 2026

(54) FOAMING ORANGE MULTI-PURPOSE CLEANER

(71) Applicant: Energizer Auto, Inc., St. Louis, MO (US)

(72) Inventors: Qin Chen, Westerville, OH (US); Sarah Springer, Westlake, OH (US); Anthony J. Kropinak, Bay Village, OH (US); Sara Rebecca Groetsch, North Ridgeville, OH (US)

(73) Assignee: Energizer Auto, Inc., St. Louis, MO (US)

(21) Appl. No.: 19/067,576

(22) Filed: Feb. 28, 2025

Related U.S. Application Data
(60) Provisional application No. 63/559,522, filed on Feb. 29, 2024.

(51) Int. Cl. C11D 1/90; C11D 1/14; C11D 1/29; C11D 3/33; C11D 3/34; C11D 3/43; C11D 3/50

(52) U.S. Cl. CPC C11D 1/90; C11D 1/146; C11D 1/29; C11D 3/33; C11D 3/349; C11D 3/43; C11D 3/50; C11D 2111/14; C11D 2111/40

(57) ABSTRACT

The present disclosure describes a cleaning composition, wherein the cleaning composition includes one or more betaine surfactants, one or more anionic surfactants, one or more chelating agents, and one or more solvents, and wherein the one or more solvents include at least water and an organic solvent. The present disclosure also describes a method of preparing the cleaning composition, wherein the method includes combining and mixing one or more betaine surfactants, one or more anionic surfactants, one or more chelating agents, and one or more solvents, the one or more solvents including at least water and an organic solvent.

### CROSS-REFERENCE TO RELATED APPLICATIONS

This application claims the benefit of U.S. Provisional Application No. 63/559,522, filed Feb. 29, 2024, which is incorporated herein by reference in its entirety.

### FIELD OF THE DISCLOSURE

The current disclosure discloses multi-purpose cleaning compositions in a liquid form, and in a spray kit and configured to form a foam when sprayed for cleaning surfaces including the surfaces of vehicles. The current disclosure also discloses a process for washing surfaces using the cleaning composition.

### BACKGROUND OF THE DISCLOSURE

Effective exterior and interior multi-purpose cleaners for vehicles are difficult to develop. Vehicle exterior and interior surfaces include a wide range of materials, such as paint, glass, tires, wheels, and other metal components, fabric, carpet, plastic, leather, and wood. Vehicle exteriors and interiors also are exposed to different environmental conditions. Exterior surfaces frequently become contaminated with dirt, salt, grease, bugs, tree sap, and bird droppings, for example. This contamination is compounded with sun and other environmental exposure conditions which can make contaminants more difficult to remove. Interior surfaces may also become contaminated with dirt, salt, and other exterior contaminants, but interiors are also exposed to, for example, food, drink, bodily fluids, cosmetics, and/or chemicals. When not in use, vehicle interiors may not allow ventilation and may experience elevated temperatures when exposed to the sun, which promotes the formation of mold and mildew when water and/or other contaminants are present. Interior contaminants may also become more difficult to remove when exposed to elevated temperatures. Cleaning products that are suitable for use on vehicle exteriors are formulated to be safe and effective on exterior materials and to address exterior contaminants and conditions. These products are often not suitable for use on vehicle interiors and may instead cause additional contamination or damage to vehicle interiors. Similarly, cleaning products suitable for vehicle interiors are formulated to be safe and effective on interior materials and to address interior contaminants. As such, interior products may not be effective for cleaning vehicle exteriors and may cause additional contamination or damage to exterior paint or coatings.

Consumers are burdened with the extent of cleaning tasks, materials, and contaminants presented by automotive interiors and exteriors. Specialty products and formulations for each specific material and contaminant exist, but there is a significant burden to consumers to know which product may be safe and effective to use for each condition. Additionally, it may be cost-prohibitive, time-consuming, and cumbersome for consumers to purchase a different product for each cleaning task. Therefore, there is a need for a safe and effective multi-purpose cleaning product that can address both exterior and interior surfaces, especially those of vehicles. A single multi-purpose cleaning product would allow consumers to save time on cleaning, money on cleaning supplies, and would be easier for consumers to use and store.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes cleaning compositions including components that interact together to form foaming compositions. The components of the compositions described herein include water, one or more betaine surfactants, one or more anionic surfactants, and one or more solvents, wherein the one or more solvents include at least water and one or more organic solvents. In embodiments, the one or more solvents include a glycol ether. Optionally, the compositions described herein include one or more preservatives and a fragrance.

In embodiments, the cleaning compositions described herein include deionized water, cocamidopropyl betaine, sodium lauryl ether sulfate, tetrasodium ethylenediaminetetraacetate, diethylene glycol monobutyl ether, benzisothiazolinone, and a fragrance with citrus or orange aroma.

In embodiments, the present disclosure describes a kit including the compositions described herein. The kit can further include an apparatus, such as a trigger spray bottle, for dispensing the composition onto the surface.

The present disclosure also describes a method of preparing the compositions described herein including combining and mixing the components.

Moreover, the present disclosure describes a method of cleaning a surface including applying a composition described herein to the surface to clean the surface. In embodiments, the surface includes the surface of a vehicle.

### BRIEF DESCRIPTION OF THE FIGURES

FIG. 1 shows an exemplary trigger spray bottle for dispensing the compositions described herein to generate a foam.

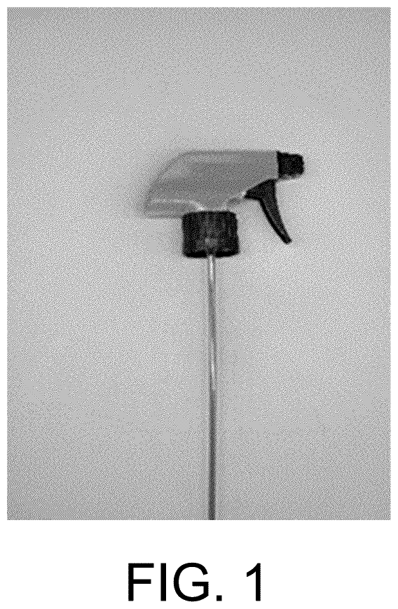

FIG. 2 shows competitive testing of an exemplary composition of the present disclosure and comparative cleaning compositions on the market on vehicle interior materials.

FIG. 3 shows competitive testing of an exemplary composition of the present disclosure and comparative cleaning compositions on the market on vehicle exterior materials.

FIG. 4 shows foaming performance of an exemplary composition of the present disclosure using a trigger spray bottle.

FIG. 5 shows cleaning performance of an exemplary method of the present disclosure on a vehicle engine.

FIG. 6 shows cleaning performance of an exemplary method of the present disclosure on black vinyl.

FIG. 7 shows cleaning performance of an exemplary method of the present disclosure on a vehicle exterior surface.

### DETAILED DESCRIPTION

The present disclosure describes methods and chemical compositions for cleaning surfaces, for example, the surfaces of vehicles. In embodiments, the compositions described herein satisfy consumers' desire for a foaming cleaner that removes heavier soils, such as from dirt, grime, bug residue, bird droppings, tree sap, sunscreen, food, beverage, cosmetics, grease, engine oil, and other contaminants from multiple interior and exterior surfaces of vehicles and is safe on both vehicle interior and exterior surfaces. The present disclosure also describes devices for dispensing the compositions, for example, a trigger spray apparatus that dispenses the vehicle cleaning composition as a foam. In embodiments, the compositions described herein include a fragrance, such as a citrus aroma, for improved customer satisfaction and use.

The cleaning compositions described herein provide improvement to previous multi-purpose cleaners, improving surface safety, cleaning performance, and customer sensory and use satisfaction. In embodiments, the foaming cleaning composition of the present disclosure allows consumers to see the composition working and reduces the amount of scrubbing and hard work needed to provide effective cleaning of surfaces. In embodiments, a fresh citrus or orange fragrance provides an improved consumer use and sensory experience. In embodiments, the foaming of the cleaning composition provides an improved indication of cleaning. The trigger spray design also assists in providing foaming of the composition. The multi-purpose cleaner compositions described herein use new chemistries with improved efficacy and consumer sensory responses.

In embodiments, the cleaning compositions described herein are safe for use on interior and exterior surfaces, especially on vehicles, such as glass, windows, mirrors, windshields, wheels, and tires. The cleaning compositions remove dirt, grime, bug residue, tree sap, bird droppings, grease, engine oil, & other contaminants from exterior and interior surfaces. In embodiments, the cleaning compositions contain an orange or fresh citrus scent. The cleaning compositions are shelf-stable for at least 2 years. The foaming trigger spray described herein contributes to ease of use and can, for example, provide cleaning without the need for scrubbing or other hard mechanical work. The cleaning compositions and foaming application described herein provide improved customer use and can outperform previous multi-purpose automotive cleaners.

The present disclosure describes cleaning compositions including components that interact to foam and clean a surface and optionally have a pleasant aroma. The one or more components of the cleaning compositions include one or more betaine surfactants, one or more anionic surfactants, one or more chelating agents, and one or more solvents. The one or more solvents include at least water and an organic solvent. Optionally, the cleaning compositions can include one or more preservatives and/or a fragrance.

Surfactants are surface-active agents that are the basic building blocks of all cleaning products. Surfactants alter the properties of water to enable it to clean. They lower the surface tension of water (makes water wetter). They also make water and oils compatible with each other through a process called emulsification. Anionic surfactants are surfactants that carry a negatively charged head group. Betaine surfactants are amphoteric surfactants. Amphoteric surfactants have both acidic and alkaline properties and a dual charge on their hydrophilic end, both positive and negative. The dual charges cancel each other out creating a net charge of zero, referred to as zwitterionic. The pH of any given solution determines how the amphoteric surfactants work.

The one or more betaine surfactants of the cleaning compositions described herein include an alkylamidopropyl betaine of the formula:

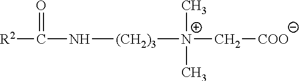

wherein R² is a C₆-C₂₂ alkyl group.

In embodiments, the one or more betaine surfactants include one or more alkylamidopropyl betaines. In embodiments, the one or more alkylamidopropyl betaines include cocamidopropyl betaine (e.g., Caltaine® C-35).

The one or more anionic surfactants of the cleaning compositions described herein include C₆-C₂₀ alkyl sulfate alkali earth metal salt. In embodiments, the one or more anionic surfactants, which are also foaming agents, include sodium lauryl ether sulfate (e.g., Calfoam® ES-303).

Chelating agents are sequestering agents or molecules capable of forming complexes with metal ions. In cleaning products, they are most commonly used to prevent soaps/detergents from reacting with the mineral deposits in hard water and forming soap scum. The mechanism by which chelating agents work is by combining with certain metal ions to form a molecular complex that locks up or chelates the metal ion so that it no longer exhibits ionic properties.

The one or more chelating agents of the cleaning compositions described herein include one or more of tetrasodium ethylenediaminetetraacetate, tetrasodium glutamate diacetate, and L-glutamic acid, N,N-diacetic acid, tetrasodium salt (GLDA). In embodiments, the one or more chelating agents include tetrasodium ethylenediaminetetraacetate (e.g., VERSENE™ 100 XL).

The one or more solvents of the cleaning compositions described herein include at least water and one or more organic solvents. The water can be deionized (DI) water, distilled water, or reverse osmosis (RO) water. In embodiments, the water is DI water. Examples of one or more organic solvents include one or more glycol ethers, such as ethylene-oxide-based glycol ether. In embodiments, the one or more organic solvents include diethylene glycol monobutyl ether (e.g., Butyl CARBITOL™).

The cleaning compositions described herein can further include one or more preservatives. Examples of preservatives include hydantoin germicide, carbamate fungicide, methylisothiazolinone (MIT), methylchloroisothiazolinone (CMIT) and benzisothiazolinone (BIT). In embodiments, the one or more preservatives include benzisothiazolinone (e.g., TROYGUARD™ BC11).

The cleaning compositions described herein can further include a fragrance, an aroma, or a source of fragrance or aroma that can be formulated into the cleaning formulation. In embodiments, the fragrance includes a citrus or orange aroma (e.g., CITRUS BLOOM™ 2021C). The citrus fragrance or aroma is defined by the smell of a citrus tree, such as orange, both sweet and bitter, and lemons. Citrus notes are rather volatile and often used in the top opening notes to add freshness to a fragrance. The cleaning composition can also include one or more odor neutralizers and/or malodor counteractants, such as an ester described in U.S. Pat. No. 7,157,411 B2, combinations of C5 and C6 cyclic aroma chemicals described in U.S. Pat. No. 6,403,075 B1, olfactory cross-adaptation agents described in U.S. Publication 2003/0152538 A1, methanoindene compounds described in WO 2003/070871 A1, or 3-mercapto-3-methyl-hexan-1-ol as described in WO 2006/003053 A1. The one or more odor neutralizers and/or malodor counteractants may utilize masking, partial pressure reduction, and cross-adaption to help reduce malodors. Malodor reducing agents may include menthyl acetate, ambrocenide, ambroxid crystals, boronal, nerolione, citronitrile, irisnitrile, florazon, globanone, globalide, macrolide, ketamber, synambran, sandranol, majantol, mugetanol, farenal, ozonil, rosaphen, or timberol. The one or more malodor reducing agents can be added to the one or more fragrances or be added to the compositions described herein separately from the fragrance. The one or more malodor reducing agents can also be added to the compositions described herein without the fragrance and the one or more fragrances can also be used without a malodor reducing agent.

The cleaning compositions described herein include by total weight of the composition:
about 85.000% to 95.000%, about 87% to 94%, about 89% to 93%, about 90% to 93%, about 91% to 93%, about 92% to 93%, or about 92.475% water;
about 1.000% to 5.000%, about 2.000% to 4.000%, about 2.500% to 3.500%, or about 3.000% of one or more betaine surfactants;
about 1.000% to 5.000%, about 2.000% to 4.000%, about 3.000% to 4.000%, or about 3.500% of one or more anionic surfactants;
about 0.050% to 0.500%, about 0.075% to 0.250%, about 0.100% to 0.200%, or about 0.125% of one or more chelating agents; and
about 0.100% to 1.000%, about 0.200% to 0.800%, about 0.400% to 0.600%, or about 0.500% of one or more organic solvents; and
optionally about 0.050% to 0.500%, about 0.050% to 0.400%, about 0.075% to 0.300%, about 0.090% to 0.200%, or about 0.100% of one or more preservatives; and/or optionally about 0.100% to 0.500%, about 0.200% to 0.400%, or about 0.300% fragrance.

In embodiments, the cleaning composition described herein includes deionized water, cocamidopropyl betaine, sodium lauryl ether sulfate, tetrasodium ethylenediaminetetraacetate, diethylene glycol monobutyl ether, benzisothiazolinone (BIT), and a fragrance with citrus or orange aroma.

In embodiments, the cleaning composition described herein includes by total weight of the composition:
about 92.475% deionized water;
about 3.000% cocamidopropyl betaine, and optionally wherein the cocamidopropyl betaine is Caltaine® C-35;
about 3.500% sodium lauryl ether sulfate, and optionally wherein the sodium lauryl ether sulfate is Calfoam® ES-303;
about 0.125% tetrasodium ethylenediaminetetraacetate, and optionally wherein the tetrasodium ethylenediaminetetraacetate is VERSENE™ 100 XL;
about 0.500% diethylene glycol monobutyl ether, and optionally wherein the diethylene glycol monobutyl ether is Butyl CARBITOL™;
about 0.100% benzisothiazolinone, and optionally wherein the benzisothiazolinone is TROYGUARD™ BC11; and
about 0.300% fragrance with citrus or orange aroma.

In embodiments, each of the components can be a mixture including the main ingredient and some other ingredients. For example, VERSENE™ 100 XL can include tetrasodium ethylenediamine tetraacetate as the main ingredient and sodium hydroxide and water, and TROYGUARD™ BC11 can include benzisothiazol-3(2h)-one (BIT) as the main ingredient, and 5-chloro-2-methyl-4-isothiazolin-3-one (CMIT), and 2-methyl-2H-isothiazol-3-one (MIT). Caltaine® C-35 can include 1-propanaminium, 3-amino-n-(carboxymethyl)-n,n-dimethyl-, N-coco acyl derivs., inner salts as the main ingredient; and 1,2,3-propanotriol. Calfoam® ES-303 can include alpha-sulfo-omega-hydroxypoly(oxy-1,2-ethanidiyl)C10-16 alkyl ethers, sodium salts; and sodium sulfate. The other ingredients in each component can also include amounts of ingredients that are below reportable levels. The other ingredients can also include small amounts of impurities. For example, Calfoam® ES-303 can include C10-16, ethoxylated alcohols as an impurity, and Caltaine® C-35 can include citric acid as an impurity.

The present disclosure describes methods of preparing the cleaning compositions described herein, wherein the method includes combining each of the components of the composition and mixing them to form a composition. In embodiments, the method includes combining one or more betaine surfactants, one or more anionic surfactants, one or more chelating agents, and one or more solvents, the one or more solvents including at least water and an organic solvent and mixing the components to form a composition. In embodiments, if one or more preservatives are to be included in the compositions described herein, the methods include combining the one or more preservatives with the water first and mixing with high energy before adding the other components. The other components such as one or more betaine surfactants, one or more anionic surfactants, one or more chelating agents, and one or more organic solvents can be added sequentially with constant mixing or at the same time and mixed. Once the one or more anionic surfactants (foaming agents) are added, the mixing speed should be lowered to reduce foaming. In embodiments, the components can be placed in a container and mixed. In embodiments, a fragrance can be added.

The methods of preparing the cleaning compositions can further include adding one or more preservatives and/or a fragrance. In embodiments, the fragrance has a citrus or orange aroma.

The methods of preparing the cleaning composition can further include dispensing the composition into a spray device, and optionally wherein the spray device is a trigger spray container that is configured for delivering the cleaning composition in the form of a foam to the surface to be cleaned.

The present disclosure describes containers for holding the compositions described herein. In embodiments, the container is a trigger spray bottle.

The present disclosure also describes methods of cleaning surfaces. The method includes applying a composition described herein to a surface to produce a foam for cleaning the surface and wiping the composition to cover the entire surface and to remove dirt and contaminants to clean the surface. The composition can be sprayed onto a surface using a trigger spray bottle to create a foam. The composition can also be dispensed onto an applicator and applied to the surface to create a foam on the surface. The applicator can include a sponge, a cloth, a paper towel, or a combination thereof.

The surface can be an exterior or interior surface, such as glass, window, and mirror. The surface can be the surface of a vehicle including body panels, windshield, windows, mirrors, tires, wheels, and lights, including exterior lights such as headlights and taillights, of a vehicle.

The present disclosure also describes a vehicular cleaning kit including a unit dose or multiple doses of the compositions described herein for cleaning different parts of a vehicle. The kit can include an apparatus or device, such as a trigger spray bottle for dispensing the composition onto the surface.

Examples of vehicles include automobiles, buses, trains, watercrafts including ships and boats, aircrafts including planes and helicopters, and spacecrafts.

In embodiments, it is the interaction of the combination of the one or more betaine surfactants, one or more anionic surfactants, and one or more chelating agents that provides the foaming of the composition and the effective cleaning of the surface. The combination of the components can remove heavy soils from dirt, grime, tree sap, bug residue, bird droppings, sunscreen, food, beverage, cosmetics, grease, engine oil, and other contaminants. The compositions described herein are also safe to use on multiple surfaces including interior and exterior surfaces, for example, glass surfaces of vehicles. In contrast to known cleaning compositions, the compositions described herein not only are able to clean heavily soiled surfaces but also are safe to use on various surfaces without damaging them. The compositions described herein have enhanced cleaning capability and improved compatibility with various surfaces, so that the surfaces are not damaged while being cleaned.

Additionally, the foaming of the composition enables the consumers to see that the composition is working to clean the surface which can reduce the amount of scrubbing and effort needed to effectively clean the surfaces. In embodiments, minimal or no mechanical work, such as scrubbing, is required to clean the surfaces with the compositions described herein. Further, the use of a trigger spray bottle to deliver the compositions described herein to the surface enhances the foaming of the composition.

In embodiments, a fragrance, such as a citrus or orange aroma is added to compositions described herein to provide an improved consumer use and sensory experience.

The terms “composition(s)” and “formulation(s)” are used interchangeably to refer to the compositions described herein.

The term “wt %” or “%” in the context of the weight of the component in the composition are used interchangeably to be relative to the total weight of the composition.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition, such as cleaning a surface.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

It is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are Exemplary Embodiments.
1. A cleaning composition, wherein the cleaning composition comprises one or more betaine surfactants, one or more anionic surfactants, one or more chelating agents, and one or more solvents, and wherein the one or more solvents comprise at least water and an organic solvent.
2. The cleaning composition of embodiment 1, wherein the one or more betaine surfactants comprise:
   an alkylamidopropyl betaine of the formula

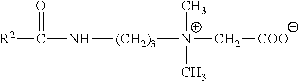

wherein R² is a C₆-C₂₂ alkyl group; and
optionally wherein the alkylamidopropyl betaine is cocamidopropyl betaine.
3. The cleaning composition of embodiment 1 or 2, wherein the one or more anionic surfactants comprise one or more C6-C₂₀ alkyl sulfate alkali earth metal salts, and optionally, wherein the one or more anionic surfactants comprise sodium lauryl ether sulfate.
4. The cleaning composition of any one of embodiments 1-3, wherein the one or more chelating agents comprise one or more of tetrasodium ethylenediaminetetraacetate, tetrasodium glutamate diacetate, and L-glutamic acid, N,N-diacetic acid, tetrasodium salt (GLDA), and optionally wherein the one or more chelating agents comprise tetrasodium ethylenediaminetetraacetate.
5. The cleaning composition of any one of embodiments 1-4, wherein the water comprises deionized water.
6. The cleaning composition of any one of embodiments 1-5, wherein the one or more organic solvents comprise one or more glycol ethers.
7. The cleaning composition of any one of embodiments 1-6, wherein the one or more organic solvents comprise one or more ethylene-oxide-based glycol ethers, and optionally wherein the organic solvent comprises diethylene glycol monobutyl ether.
8. The cleaning composition of any one of embodiments 1-7, wherein the composition further comprises one or more preservatives, and optionally wherein the one or more preservatives comprise one or more of benzisothiazolinone (BIT), hydantoin germicide, carbamate fungicide, methylisothiazolinone (MIT), and methylchloroisothiazolinone (CMIT).
9. The cleaning composition of any one of embodiments 1-8, wherein the composition further comprises a fragrance, an odor neutralizer, and/or a malodor counteractant, and optionally wherein the fragrance comprises a citrus or orange aroma.
10. The cleaning composition of any one of embodiments 1-9, wherein the cleaning composition comprises by total weight of the composition:
   about 85.000% to 95.000% water;
   about 1.000% to 5.000% of one or more betaine surfactants;
   about 1.000% to 5.000% of one or more anionic surfactants;
   about 0.050% to 0.500% of one or more chelating agents; and
   about 0.100% to 1.000% of one or more organic solvents; and
   optionally:
   about 0.050% to 0.500% of one or more preservatives; and/or about 0.100% to 0.500% of one or more fragrance, odor neutralizer, and malodor counteractant.
11. The cleaning composition of any one of embodiments 1-10, wherein the cleaning composition comprises deionized water, cocamidopropyl betaine, sodium lauryl ether sulfate, tetrasodium ethylenediaminetetraacetate, diethylene glycol monobutyl ether, benzisothiazolinone, and a fragrance with citrus or orange aroma.
12. The cleaning composition of any one of embodiments 1-11, wherein the cleaning composition comprises by total weight of the composition:
   about 92.475% deionized water;
   about 3.000% cocamidopropyl betaine;
   about 3.500% sodium lauryl ether sulfate;
   about 0.125% tetrasodium ethylenediaminetetraacetate;
   about 0.500% diethylene glycol monobutyl ether;
   about 0.100% benzisothiazolinone; and
   about 0.300% fragrance with citrus or orange aroma.
13. A method of preparing the cleaning composition of any one of embodiments 1-12, wherein the method comprises combining and mixing one or more betaine surfactants, one or more anionic surfactants, one or more chelating agents, and one or more solvents, the one or more solvents comprising at least water and an organic solvent.
14. The method of embodiment 13, wherein the method further comprises adding one or more preservatives to the composition, and wherein the one or more preservatives are first mixed with water before adding other components of the composition.
15. The method of claim 13 or 14, wherein the method further comprises adding one or more of a fragrance, odor neutralizer, and malodor counteractant and optionally wherein the fragrance has a citrus or orange aroma.
16. The method of any one of embodiments 13-15, wherein the method further comprises dispensing the composition in a bottle, and optionally wherein the spray bottle is a trigger spray bottle.
17. A method of cleaning a surface, wherein the method comprises applying the composition of any one of embodiments 1-12 to the surface to produce a foam for cleaning the surface.
18. The method of embodiment 17, wherein the surface is a vehicular surface.
19. The method of embodiment 17 or 18, wherein the surface comprises an interior and/or exterior of a vehicular surface.
20. The method of any one of embodiments 17 to 19, wherein the surface comprises body panels, windshield, windows, mirrors, tires, wheels, and lights of a vehicle.
21. The method of any one of embodiments 17-20, wherein cleaning the surface includes removing contaminants from the surface, and optionally the contaminants comprise one or more of dirt grime, bug residue, tree sap, bird droppings, sunscreen, food, and beverage, cosmetics, and grease including engine oil.
22. A container comprising the cleaning composition of any one of embodiments 1-12, wherein the container is a bottle, and optionally wherein the bottle is a spray bottle or a trigger spray bottle.

### EXAMPLES

Representative embodiments of the present disclosure will now be described with reference to the following examples that illustrate the principles and practice of the present disclosure.

Vehicle cleaning compositions were prepared as shown in the Examples below.

### Example 1

TABLE 1

| | | Component |
|---|---|---|
| Component | Function | Quantity |
| DI Water | Solvent | 92.475 |
| Caltaine ® C-35 | Betaine Surfactant | 3.000 |
| Calfoam ® ES-303 | Anionic Surfactant | 3.500 |
| VERSENE ™ 100 XL | Chelating Agent | 0.125 |
| Butyl CARBITOL ™ | Solvent | 0.500 |
| TROYGUARD ™ BC-11 | Preservative | 0.100 |
| CITRUS BLOOM ™ 2021C | Fragrance | 0.300 |
| Total | | 100.00 |

The composition of Example 1 was prepared by combining the preservative with DI water in a container and mixing with high energy. The mixing is then lowered or reduced for the addition of the rest of the components, especially for the anionic surfactant (foaming agent). The other components of the composition are subsequently added together or sequentially to the container with constant mixing.

TABLE 2

| | | Component |
|---|---|---|
| Component | Function | Quantity |
| Water | Solvent | 92.475-98.100 |
| cocamidopropyl betaine | Betaine Surfactant | 0.700-3.000 |
| sodium lauryl ether sulfate | Anionic Surfactant | 0.600-3.500 |
| tetrasodium | Chelating Agent | 0.04-0.125 |
| ethylenediaminetetraacetate | | |
| diethylene glycol monobutyl | Solvent | 0.400-0.500 |
| ether | | |
| benzisothiazolinone | Preservative | 0.010-0.100 |
| citrus aroma | Fragrance | 0.150-0.300 |
| Total | | 100.00 |

The composition of Example 2 was prepared as described in Example 1.

### Experimental Examples

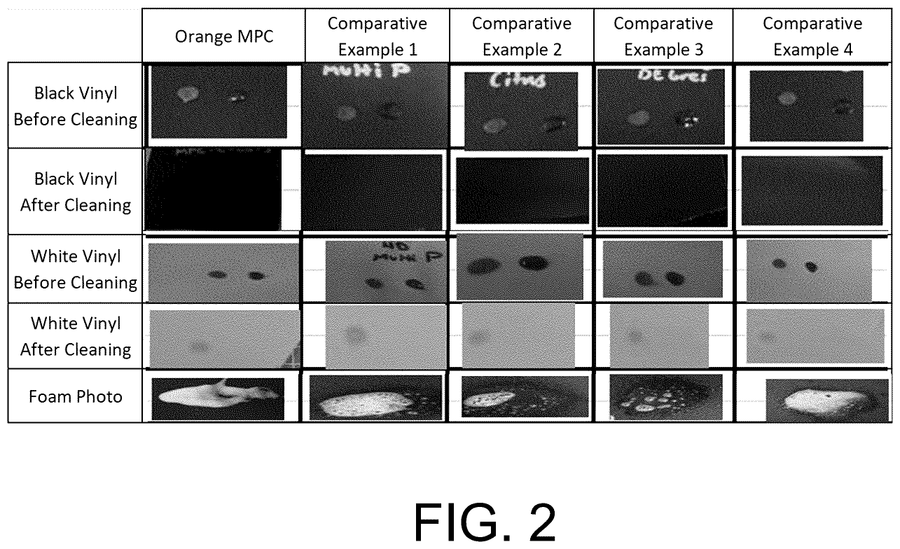

Interior cleaning competitive testing was performed. FIG. 2 shows photos of the performance of an exemplary composition (Orange MPC, composition of Example 1) of the present disclosure and comparative cleaning examples 1 to 4. Comparative Examples 1 to 4 are multi-purpose cleaning compositions available on the market. Cleaning was performed on vehicle interior materials black vinyl (BV) and white leather (WL). To test each composition, stains (ketchup and mustard) were applied to the material, left for 24 hours at room temperature and ambient conditions, and cleaned with the composition. Numeric ratings were also given to each composition's cleaning performance. Table 3 presents the numeric cleaning values as well as pH, safety, ease of cleaning, and foam rating data for each composition used in the interior cleaning competitive test shown in FIG. 2. Safety values range from 0 to 4, where 4 is most severe. Cleaning values range from 0 to 1, where 5 is completely removed. Ease of cleaning ranges from 0 to 5, where 5 is easiest cleaning. Foaming values range from 0 to 5, where 5 is the most foam.

TABLE 3

| Performance | Orange | Comparative | Comparative | Comparative | Comparative |
|---|---|---|---|---|---|
| Attribute | MPC | Example 1 | Example 2 | Example 3 | Example 4 |
| pH | 7.6 | 10.1 | 10.5 | 10.5 | 11.3 |
| Safety on BV | 0 | 0 | — | — | 0 |
| Safety on WL | 0 | 0 | — | — | 1 |
| Cleaning | 5 | 5 | 5 | 4 | 5 |
| Ketchup BV | | | | | |
| Cleaning | 5 | 5 | 4 | 5 | 5 |
| Mustard BV | | | | | |
| Ease of | 5 | 5 | 5 | 5 | 5 |
| cleaning BV | | | | | |
| Cleaning | 5 | 5 | 4 | 4 | 5 |
| Ketchup WL | | | | | |
| Cleaning | 3 | 3 | 3 | 3 | 3 |
| Mustard WL | | | | | |
| Ease of | 4 | 4 | 4 | 4 | 4 |
| cleaning WL | | | | | |
| Foam Rating | 5 | 4 | 3 | 2 | 4 |

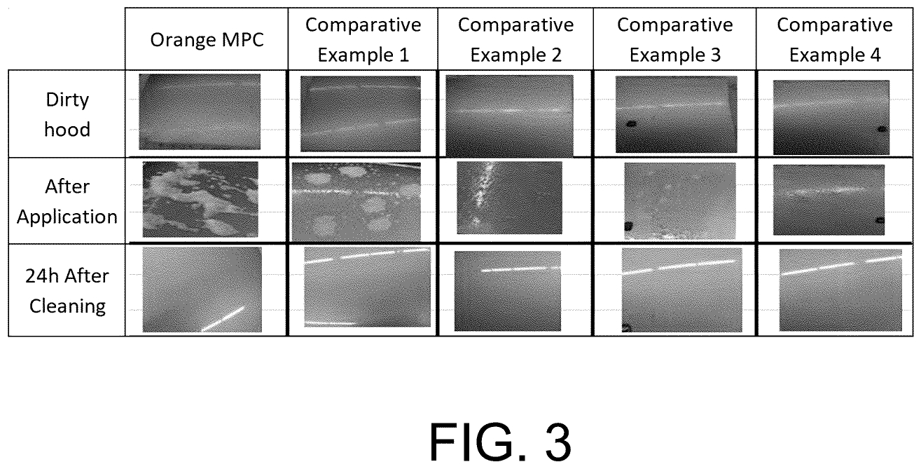

Exterior cleaning competitive testing was performed. FIG. 3 shows photos of the performance of an exemplary composition of the present disclosure and comparative cleaning examples 1 to 4. Comparative Examples 1 to 4 are multi-purpose cleaning compositions available on the market. Cleaning was performed on a vehicle exterior material (vehicle hood). To test each composition, a vehicle hood was soiled with dirt and grime, left for 24 hours at ambient conditions, and cleaned with the composition. Numeric ratings were also given to each composition's cleaning performance after initial cleaning and 24 hours after cleaning. Table 4 presents the numeric cleaning values as well as pH, safety, ease of cleaning, and foam rating data for each composition used in the exterior cleaning competitive test shown in FIG. 3. Safety values range from 0 to 4, where 4 is most severe. Cleaning values range from 0 to 1, where 5 is completely removed. Ease of cleaning ranges from 0 to 5, where 5 is easiest cleaning. Foaming values range from 0 to 5, where 5 is the most foam.

TABLE 4

| Performance | Orange | Comparative | Comparative | Comparative | Comparative |
|---|---|---|---|---|---|
| Attribute | MPC | Example 1 | Example 2 | Example 3 | Example 4 |
| pH | 7.6 | 10.1 | 10.5 | 10.5 | 11.3 |
| Safety | 0 | 1 | 1 | 2 | 3 |
| Ease of cleaning | 5 | 5 | 4 | 3 | 4 |
| Initial Cleaning | 5 | 5 | 3 | 4 | 3 |
| 24 hr after cleaning | 5 | 5 | 3 | 4 | 3 |
| Foaming | 5 | 3 | 2 | 2 | 2 |

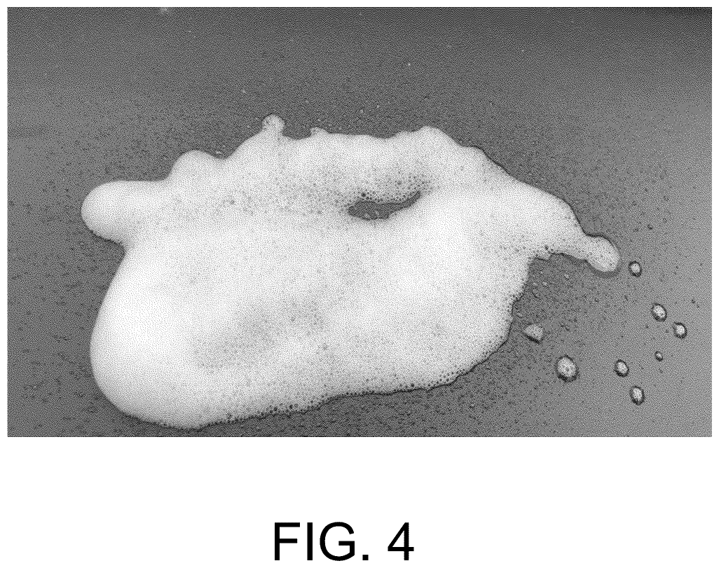

FIG. 4 shows foaming performance of an exemplary composition of the present disclosure using a trigger spray bottle described herein.

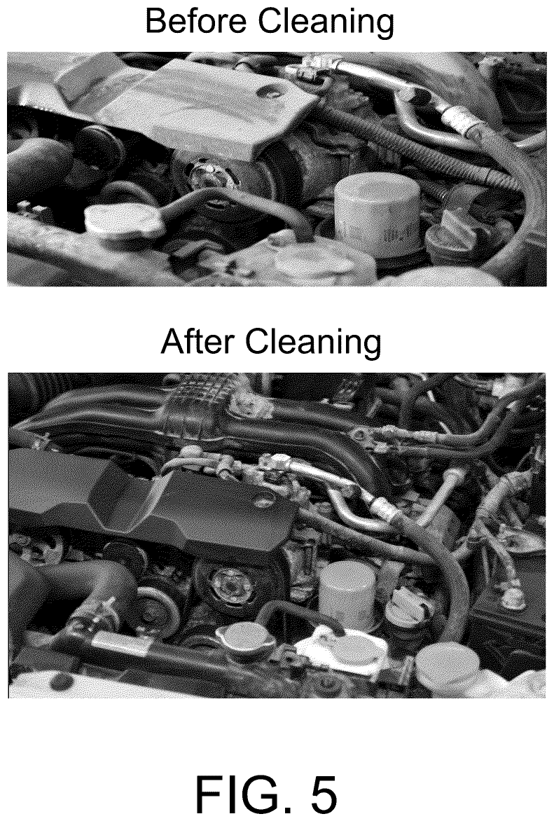

FIG. 5 shows cleaning performance of an exemplary method of the present disclosure on a vehicle engine. An exemplary composition of the present disclosure was applied to the surfaces shown in the upper image of FIG. 5 “Before Cleaning.” The composition was then wiped from the surfaces. The cleaning results are shown in the lower image of FIG. 5 “After Cleaning.”

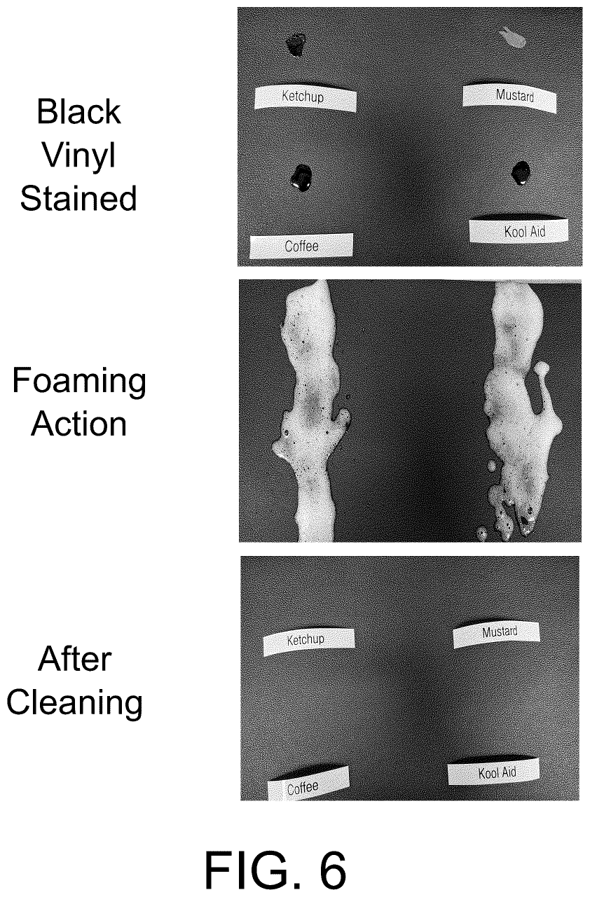

FIG. 6 shows cleaning performance of an exemplary method of the present disclosure on black vinyl. Ketchup, mustard, coffee, and Kool Aid were applied to a black vinyl surface (see FIG. 6, upper image “Black Vinyl-Stained”). An exemplary composition of the present disclosure was applied to the stains (see FIG. 6, middle image “Foaming Action”). The composition was then wiped from the surface, and the results after cleaning are shown in the lower image of FIG. 6 “After Cleaning”.

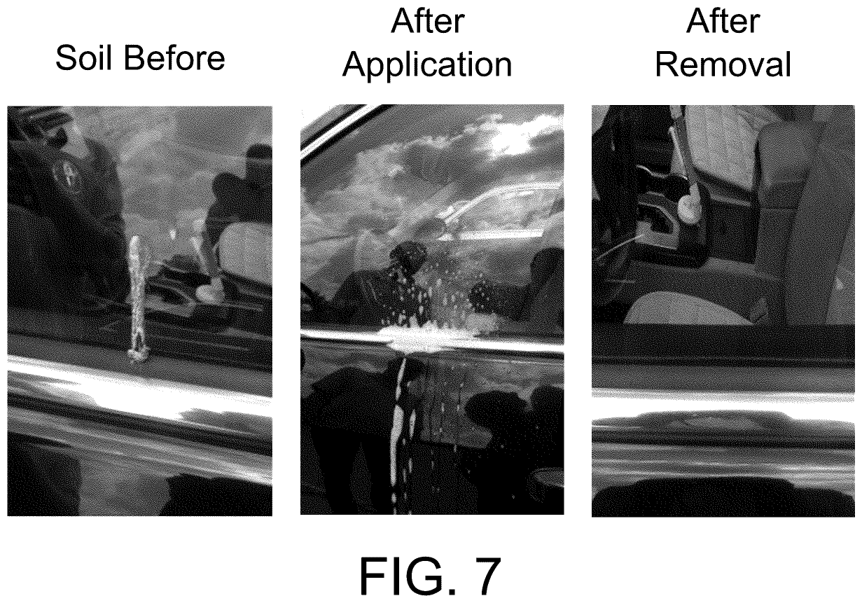

FIG. 7 shows cleaning performance of an exemplary method of the present disclosure on a vehicle exterior surface. A bird dropping (see FIG. 7 left image “Soil Before”) was cleaned using an exemplary composition of the present disclosure. The composition was applied to the soil (see FIG. 7 middle image “After Application”). The composition was then wiped from the surface, and the results after cleaning are shown in the right image of FIG. 7 “After Removal”.

1. A cleaning composition, wherein the cleaning composition comprises one or more betaine surfactants, one or more anionic surfactants, one or more chelating agents, and one or more solvents, and wherein the one or more solvents comprise at least water and an organic solvent.

2. The cleaning composition of claim 1, wherein the one or more betaine surfactants comprise: an alkylamidopropyl betaine of the formula 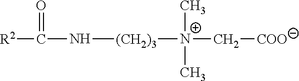
wherein R² is a C₆-C₂₂ alkyl group; and
optionally wherein the alkylamidopropyl betaine is cocamidopropyl betaine.

3. The cleaning composition of claim 1, wherein the one or more anionic surfactants comprise one or more C₆-C₂₀ alkyl sulfate alkali earth metal salts, and optionally, wherein the one or more anionic surfactants comprise sodium lauryl ether sulfate.

4. The cleaning composition of claim 1, wherein the one or more chelating agents comprise one or more of tetrasodium ethylenediaminetetraacetate, tetrasodium glutamate diacetate, and L-glutamic acid, N,N-diacetic acid, tetrasodium salt (GLDA), and optionally wherein the one or more chelating agents comprise tetrasodium ethylenediaminetetraacetate.

5. The cleaning composition of claim 1, wherein the water comprises deionized water.

6. The cleaning composition of claim 1, wherein the one or more organic solvents comprise one or more glycol ethers.

7. The cleaning composition of claim 1, wherein the one or more organic solvents comprise one or more ethylene-oxide-based glycol ethers, and optionally wherein the organic solvent comprises diethylene glycol monobutyl ether.

8. The cleaning composition of claim 1, wherein the composition further comprises one or more preservatives, and optionally wherein the one or more preservatives comprise one or more of benzisothiazolinone (BIT), hydantoin germicide, carbamate fungicide, methylisothiazolinone (MIT), and methylchloroisothiazolinone (CMIT).

9. The cleaning composition of claim 1, wherein the composition further comprises a fragrance, an odor neutralizer, and/or a malodor counteractant, and optionally wherein the fragrance comprises a citrus or orange aroma.

10. The cleaning composition of claim 1, wherein the cleaning composition comprises by total weight of the composition:
about 85.000% to 95.000% water;
about 1.000% to 5.000% of one or more betaine surfactants; about 1.000% to 5.000% of one or more anionic surfactants; about 0.050% to 0.500% of one or more chelating agents;
and about 0.100% to 1.000% of one or more organic solvents; and optionally: about 0.050% to 0.500% of one or more preservatives; and/or about 0.100% to 0.500% of one or more fragrance, odor neutralizer, and malodor counteractant.

11. The cleaning composition of claim 1, wherein the cleaning composition comprises deionized water, cocamidopropyl betaine, sodium lauryl ether sulfate, tetrasodium ethylenediaminetetraacetate, diethylene glycol monobutyl ether, benzisothiazolinone, and a fragrance with citrus or orange aroma.

12. The cleaning composition of claim 1, wherein the cleaning composition comprises by total weight of the composition:
about 92.475% deionized water;
about 3.000% cocamidopropyl betaine;
about 3.500% sodium lauryl ether sulfate;
about 0.125% tetrasodium ethylenediaminetetraacetate;
about 0.500% diethylene glycol monobutyl ether;
about 0.100% benzisothiazolinone; and
about 0.300% fragrance with citrus or orange aroma.

13. A method of preparing the cleaning composition of claim 1, wherein the method comprises combining and mixing one or more betaine surfactants, one or more anionic surfactants, one or more chelating agents, and one or more solvents, the one or more solvents comprising at least water and an organic solvent.

14. The method of claim 13, wherein the method further comprises adding one or more preservatives to the composition, and wherein the one or more preservatives are first mixed with water before adding other components of the composition.

15. The method of claim 13, wherein the method further comprises adding one or more of a fragrance, odor neutralizer, and malodor counteractant and optionally wherein the fragrance has a citrus or orange aroma.

16. The method of claim 13, wherein the method further comprises dispensing the composition in a bottle, and optionally wherein the spray bottle is a trigger spray bottle.

17. A method of cleaning a surface, wherein the method comprises applying the composition of claim 1 to the surface to produce a foam for cleaning the surface.

18. The method of claim 17, wherein the surface is a vehicular surface.

19. The method of claim 17, wherein the surface comprises an interior and/or exterior of a vehicular surface.

20. The method of claim 17, wherein the surface comprises body panels, windshield, windows, mirrors, tires, wheels, and lights of a vehicle.

21. The method of claim 17, wherein cleaning the surface includes removing contaminants from the surface, and optionally the contaminants comprise one or more of dirt grime, bug residue, tree sap, bird droppings, sunscreen, food, and beverage, cosmetics, and grease including engine oil.

22. A container comprising the cleaning composition of claim 1, wherein the container is a bottle, and optionally wherein the bottle is a spray bottle or a trigger spray bottle.
